(19) United States
(12) Patent Application Publication
(10) Pub. No.: US 2025/0043788 A1
(43) Pub. Date: Feb. 6, 2025

(54) SUMP PUMP SYSTEM HAVING A DUAL CONNECTOR ASSEMBLY

(71) Applicant: IPS Corporation, Collierville, TN (US)

(72) Inventor: Timothy Lee WrightBrandt, Muskegon, MI (US)

(21) Appl. No.: 18/790,007

(22) Filed: Jul. 31, 2024

Related U.S. Application Data
(60) Provisional application No. 63/516,598, filed on Jul. 31, 2023.

(51) Int. Cl. F04D 15/02; H01H 35/18

(52) U.S. Cl. CPC F04D 15/0218; H01H 35/186

(57) ABSTRACT

The present application generally relates to a sump pump system configured for use in a sump that may contain liquid. In one embodiment, the system includes a sump pump, first and second vertical float switches having respective piggyback end plugs, and a dual connector assembly comprising first and second electrical connectors. Male connection points of each of the vertical float switch end plugs are plugged into respective female connection points of the first electrical connector, which terminates at a single male connection point plugged into an AC power source. The second electrical connector has a single female connection point and terminates at two male connection points. The sump pump is plugged into the single female connection point of the second electrical connector, and the two male connection points of the second electrical connector are plugged into the respective female connection points of the two piggyback end plugs.

### CROSS-REFERENCE TO RELATED APPLICATIONS

This application claims priority to, and the benefit of, U.S. Provisional Patent Application No. 63/516,598, titled Sump Pump System Having a Dual Connector Assembly, filed on Jul. 31, 2023, which is incorporated herein in its entirety by reference.

### FIELD

The present disclosure relates to systems and components thereof configured for use in a sump that may contain a liquid.

### BACKGROUND

Generally speaking, a sump pump system is configured for use in a low-lying area called a sump (e.g., a pit or well) that may collect liquids such as water and/or chemicals. A sump pump is positioned in the sump to transfer liquid accumulated therein from one position to another, typically from inside the sump to an area outside the sump. As an example, a basement that may be prone to flooding may use a sump pump installed within the basement to transfer accumulated water to another location outside the basement. In some instances, once a sufficient amount of water is transferred from the basement, the sump pump will shut off until a need arises again to transfer water from within the basement.

### BRIEF SUMMARY

The present disclosure relates to a sump pump system for use in a sump that may contain a liquid. The present disclosure includes, without limitation, the following implementations.

In one implementation, the present disclosure provides a sump pump system comprising a sump pump configured for pumping at least a portion of the liquid from the sump, a first vertical float switch, a second vertical float switch, and a dual connector assembly. In some implementations, the first vertical float switch comprises a first flow switch rod, a first float switch top position stop, a first float switch bottom position stop, a first float switch float ball configured to travel along at least a portion of the first float switch rod between the first flow switch top position stop and the first float switch bottom position stop, and a first float switch power cable terminating at a first float switch end plug having a male connection point and a female connection point. In some implementations the second vertical float switch comprises a second flow switch rod, a second float switch top position stop, a second float switch bottom position stop, a second float switch float ball configured to travel along at least a portion of the second float switch rod between the second flow switch top position stop and the second float switch bottom position stop, and a second float switch power cable terminating at a second float switch end plug having a male connection point and a female connection point.

In some implementations, the dual connector assembly comprises a first electrical connector and a second electrical connector, wherein the first electrical connector includes first and second female connection points electrically coupled to a single male connection point, and the second electrical connector includes a single female connection point electrically coupled to first and second male connection points, wherein the single female connection point of the second electrical connector is electrically connected to the sump pump, wherein the single male connection point of the first electrical connector is configured to be electrically connected to a power source, and the first float switch end plug and the second float end plug are inserted between first and second electrical connectors such that the male connection point of the first float switch end plug is electrically connected to the first female connection point of the first electrical connector, the male connection point of the second float switch end plug is electrically connected to the second female connection point of the first electrical connector, the first male connection point of the second electrical connector is electrically connected to the female connection point of the first float switch end plug, and the second male connection point of the second electrical connector is electrically connected to the female connection point of the second float switch end plug.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as intended, namely to be combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWINGS

The present disclosure will become more fully understood from the detailed description and the accompanying drawings.

FIG. 1 is a schematic view of a sump and a sump pump system, according to an example implementation of the present disclosure;

FIG. 2 is an illustration of a vertical float switch for use with the sump pump system of FIG. 1, according to an example implementation of the present disclosure; and

FIG. 3 is an illustration of a dual connector assembly for use with the sump pump system of FIG. 1, according to an example implementation of the present disclosure.

### DETAILED DESCRIPTION

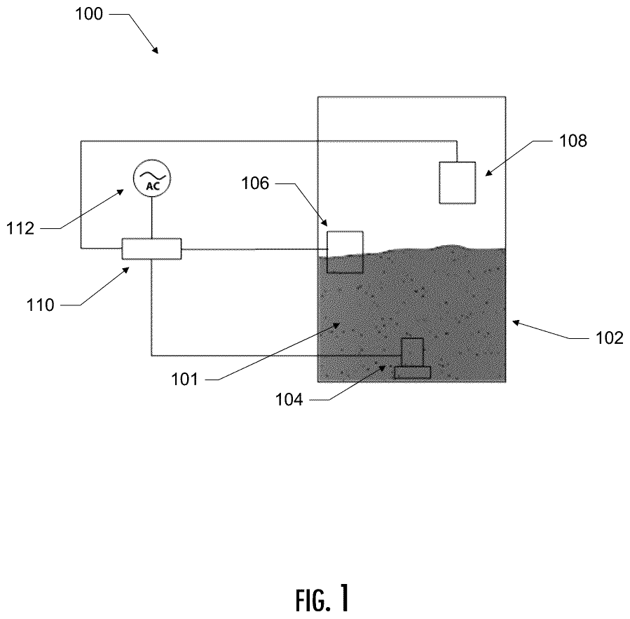

FIG. 1 illustrates a schematic view of a sump and a sump pump system, according to one example implementation of the present disclosure. In particular, FIG. 1 shows a sump pump system 100 for use in transferring at least a portion of liquid 101 that may accumulate in a sump 102. In the depicted implementation, the sump pump system 100 includes a sump pump 104, a first vertical float switch 106, a second vertical float switch 108, and a dual connector assembly 110. In the depicted implementation, the dual connector assembly 110 is electrically connected to the first and second vertical float switches 106, 108, the sump pump 104, and an AC power source. In other implementations, other power sources may be used, such as, for example, a DC power source.

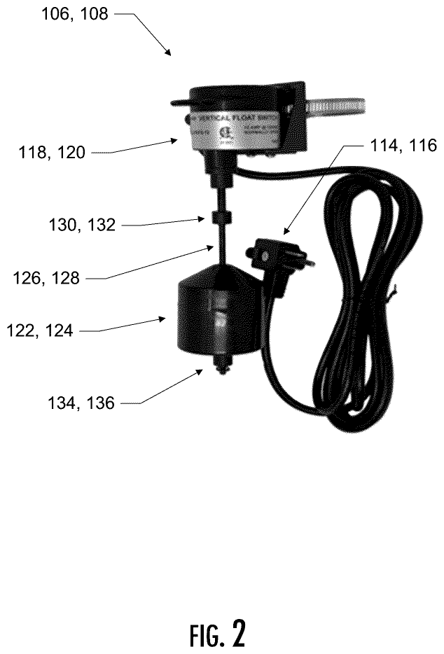

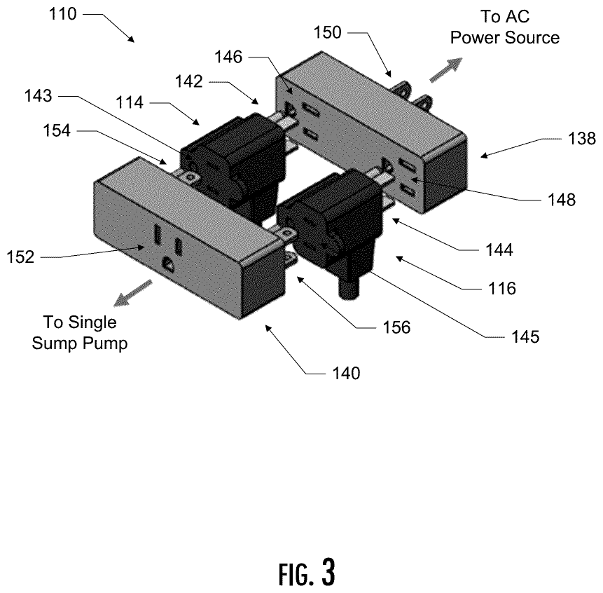

FIG. 2 illustrates an example of a vertical float switch for use with the sump pump system of FIG. 1, according to one example implementation of the present disclosure. In particular, FIG. 2 shows the components of the first and second vertical float switches 106, 108. Specifically, the first vertical float switch 106 includes a first flow switch rod 126, a first float switch top position stop 130, a first float switch bottom position stop 134, a first float switch float ball 122 configured to travel along at least a portion of the first float switch rod 126 between the first flow switch top position stop 130 and the first float switch bottom position stop 134, and a first float switch power cable terminating at a first float switch end plug 114, which is a piggyback end plug having a male connection point 142 (see FIG. 3) and a female connection point 143 on the backside thereof. Likewise, the second vertical float switch 108 includes a second flow switch rod 128, a second float switch top position stop 132, a second float switch bottom position stop 136, a second float switch float ball 124 configured to travel along at least a portion of the second float switch rod 128 between the second flow switch top position stop 132 and the second float switch bottom position stop 136, and a second float switch power cable terminating at a second float switch end plug 116, which is a piggyback end plug having a male connection point 144 (see FIG. 3) and a female connection point 145 on the back side thereof.

It should be noted that although the first and second vertical float switches of the depicted implementation are identical, in other implementations, one of the first or second vertical float switches may differ. In addition, although the float switches of the depicted implementation are vertical float switches, in other implementations, other types of switches may be used, including other mechanical and/or electrical switches, with may or may not be vertical float switches.

In the depicted implementation, both the first vertical float switch 106 and the second vertical float switch 108 work in the same manner. In particular, each of the vertical float switches 106, 108 comprises a simple mechanical ON/OFF switch. In such a manner, the switch is mechanically turned “ON” when the float ball 122, 124, which travels vertically along the respective float rod 126, 128, reaches the top position stop 130, 132, and the switch is mechanically turned “OFF” when the float ball 122, 124 reaches the bottom position stop 134, 136. When in the “ON” position, the end plugs 114, 116 of each of the respective vertical float switches 106, 108 permits an electrical connection through the end plug 114, 116. When in the “OFF” position, the end plugs 114, 116 of each of the respective vertical float switches 106, 108 prohibits an electrical connection through the plug 114, 116.

As illustrated in FIG. 1, the dual connector assembly 110 of the sump pump system 100 is electrically connected to the AC power source 112, the single sump pump 104 located in the sump 102, and the first and second vertical float switches 106, 108, which include respective piggyback end plugs 114, 116.

FIG. 3 is an illustration of a dual connector assembly for use with the sump pump system of FIG. 1, according to an example implementation of the present disclosure. In particular, FIG. 3 shows that when the dual connector assembly 110 is assembled, the vertical float switch end plugs 114, 116 are “sandwiched” between a first electrical connector 138 and a second electrical connector 140. As shown in the figure, the male connection points 142, 144 of each of the vertical float switch end plugs 114, 116 are plugged into respective female connection points 146, 148 of the first electrical connector 138, which terminates at a single male connection point 150 configured to be plugged into the AC power source 112. The second electrical connector 140 has a single female connection point 152 and terminates at two male connection points 154, 156. The sump pump 104 is plugged into the single female connection point 152 of the second electrical connector 152, and the two male connection points 154, 156 of the second electrical connector 140 are plugged into the respective female connection points 143, 145 of the two end plugs 114, 116.

More specifically, the first electrical connector 138 includes a first female connection point 146 and a second female connection point 148, which are electrically coupled to a single male connection point 150. The second electrical connector 140 includes a single female connection point 152 electrically coupled to first and second male connection points 154, 156. The single female connection point 152 of the second electrical connector is electrically connected to the sump pump 104, and the single male connection point 150 of the first electrical connector 138 is electrically connected to the AC power source 112. The first float switch end plug 114 and the second float switch end plug 116 are inserted between the first and second electrical connectors 138, 140 such that the male connection point 142 of the first float switch end plug 114 is electrically connected to the first female connection point 146 of the first electrical connector 138, the male connection point 144 of the second float switch end plug 116 is electrically connected to the second female connection point 148 of the first electrical connector 138. The first male connection point 154 of the second electrical connector 140 is electrically connected to the female connection point 143 of the first float switch end plug 114, and the second male connection point 156 of the second electrical connector 140 is electrically connected to the female connection point 145 of the second float switch end plug 116.

As illustrated in FIG. 1, the sump pump system 100 of the depicted implementation may be configured such that the first and second vertical float switches 106, 108 are located within the same sump 102, but at different positions, including different vertical positions. Referring also to FIG. 2, with this arrangement, if the rising level of the liquid 101 in the sump 102 causes the float ball 122 of the first vertical float switch 106 to rise to its respective top position stop 130, the switch of the first vertical float switch 106 will mechanically turn “ON” and power will be delivered to the sump pump 104. Under normal circumstances, the sump pump 104 will pump the liquid 101 out of the sump 102 until the float ball 122 of the first vertical float switch 106 reaches the bottom position stop 134, at which point the switch of first vertical float switch 106 will mechanically turn “OFF”, cutting off power to the sump pump 104. If, however, the first vertical float switch 106 is defective and fails to turn on power to the sump pump 104, the rising liquid 101 in the sump 102 will cause the float ball 124 of the second vertical float switch 108 to rise to its respective top position stop 132, which will mechanically turn “ON” such that power will be delivered to the sump pump 104. The sump pump 104 will pump the liquid 101 out of the sump 102 until the float ball reaches the bottom position stop 136, at which point the switch of second vertical float switch 108 will mechanically turn “OFF”, cutting off power to the sump pump 104. In either event, the switching “ON” and “OFF” of the sump pump 104 of the depicted implementation occurs mechanically via the first vertical float switch 106 or the second vertical float switch 108.

Many modifications and other implementations of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A sump pump system configured for use in a sump that may contain a liquid, the sump pump system comprising:
a sump pump configured for pumping at least a portion of the liquid from the sump;
a first vertical float switch comprising a first flow switch rod, a first float switch top position stop, a first float switch bottom position stop, a first float switch float ball configured to travel along at least a portion of the first float switch rod between the first flow switch top position stop and the first float switch bottom position stop, and a first float switch power cable terminating at a first float switch end plug having a male connection point and a female connection point;
a second vertical float switch comprising a second flow switch rod, a second float switch top position stop, a second float switch bottom position stop, a second float switch float ball configured to travel along at least a portion of the second float switch rod between the second flow switch top position stop and the second float switch bottom position stop, and a second float switch power cable terminating at a second float switch end plug having a male connection point and a female connection point; and
a dual connector assembly comprising a first electrical connector and a second electrical connector, wherein the first electrical connector includes first and second female connection points electrically coupled to a single male connection point, and the second electrical connector includes a single female connection point electrically coupled to first and second male connection points, wherein the female connection point of the second electrical connector is electrically connected to the sump pump, wherein the male connection point of the first electrical connector is electrically connected to a power source, wherein the first float switch end plug and the second float switch end plug are inserted between the first and second electrical connectors such that the male connection point of the first float switch end plug is electrically connected to the first female connection point of the first electrical connector, the male connection point of the second float switch end plug is electrically connected to the second female connection point of the first electrical connector, the first male connection point of the second electrical connector is electrically connected to the female connection point of the first float switch end plug, and the second male connection point of the second electrical connector is electrically connected to the female connection point of the second float switch end plug.
